(19) United States
(12) Patent Application Publication
(10) Pub. No.: US 2026/0226813 A1
(43) Pub. Date: Aug. 6, 2026

(54) CARBON DIOXIDE CAPTURE AND STORAGE BASED ON ANALYTICAL PLUME MODEL OUTPUTS

(71) Applicant: SAUDI ARABIAN OIL COMPANY, Dhahran (SA)

(72) Inventor: Mario Valderrama, Dhahran (SA)

(73) Assignee: SAUDI ARABIAN OIL COMPANY, Dhahran (SA)

(21) Appl. No.: 19/043,979

(22) Filed: Feb. 3, 2025

(51) Int. Cl. E21B 41/00; E21B 47/06; E21B 49/00; G01V 20/00

(52) U.S. Cl. CPC E21B 41/0064; E21B 47/06; E21B 49/00; G01V 20/00; E21B 2200/20

(57) ABSTRACT

A method for carbon dioxide injection and storage is described. The method includes obtaining a set of inputs from an potential site having a reservoir, obtaining a set of operating parameters related to the potential site, accumulating a volume of data that is processed in a defined time to produce a predictive model that is an analytical model, determining, with the predictive model, one or more predicted outputs based on the inputs and the set of operating parameters, validating, based on the one or more predicted outputs and without performing any numerical model simulation of the potential site, the potential site as suitable for carbon dioxide injection and storage, deploying a carbon dioxide injection system at the validated site, and injecting, using the deployed carbon dioxide injection system, carbon dioxide into the reservoir of the validated site based on the set of operating parameters.

### BACKGROUND

Whether injected carbon dioxide can be permanently stored in deep sedimentary basins without affecting groundwater quality or future leakage to the atmosphere is of importance to operators attempting to reduce carbon dioxide emissions through carbon dioxide capture and sequestration. Prior to injecting carbon dioxide subsurface for permanent storage, a subsurface carbon storage assessment should be performed, which determines whether carbon dioxide can be permanently stored subsurface. The subsurface carbon storage assessment can utilize modeling, which can be based on either numerical or analytical methods.

Currently popular numerical methods require significant amounts of data and require extensive technical and financial resources. By contrast, analytical methods require fewer inputs and can provide simplified results in less time utilizing fewer resources. Analytical methods can provide a simple estimate of the volume occupied of the injected carbon dioxide and subsequent movement in the subsurface.

### SUMMARY OF THE CLAIMED EMBODIMENTS

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for carbon dioxide injection and storage. The method includes obtaining a set of inputs from an potential site comprising a reservoir, obtaining a set of operating parameters related to the potential site, accumulating a volume of data that is processed in a defined time to produce a predictive model that is an analytical model, determining, with the predictive model, one or more predicted outputs based on the inputs and the set of operating parameters, validating, based on the one or more predicted outputs and without performing any numerical model simulation, the potential site as suitable for carbon dioxide injection and storage, wherein one of the one or more predicted outputs is a target size of the carbon dioxide plume after injection, deploying a carbon dioxide injection system at the validated site, and injecting, using the deployed carbon dioxide injection system, carbon dioxide into the reservoir of the validated site based on the set of operating parameters.

In one aspect, embodiments disclosed herein relate to a carbon dioxide storage system. The storage system includes an potential site comprising a reservoir, wherein a carbon dioxide injection operation of the potential site is defined by a set of operating parameters, a plurality of wellsite devices disposed at the potential site and gathering a set of inputs, a carbon dioxide injection system deployed at the potential site in response to a validation, a computer configured to obtain the set of inputs from the potential site, obtain the set of operating parameters related to the potential site, accumulate a volume of data that is processed in a defined time to produce a predictive model, determine, with the predictive model, one or more predicted outputs based on the set of inputs and the set of operating parameters, generate, based on the one or more predicted outputs and without performing any numerical model simulation of the potential site, the validation that the potential site is suitable for carbon dioxide injection and storage, wherein one of the one or more predicted outputs is a target size of the carbon dioxide plume after injection, and adjust, automatically, the set of operating parameters based on the predictive model, and a well controller configured to adjust one or more wellsite devices for injecting carbon dioxide into the reservoir based on the adjusted set of operating parameters, and a source of carbon dioxide. Using the analytical model eliminates time delay required for numerical model simulation and improves time expediency of validating the potential site for carbon dioxide storage.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1D illustrates a system according to one or more embodiments disclosed herein.

FIG. 2 illustrates a flowchart according to one or more embodiments disclosed herein.

FIGS. 3-4 illustrate an example according to one or more embodiments disclosed herein.

FIG. 5 illustrates a computer system according to one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, an “oil or gas well,” may include any number of “oil or gas wells” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Due to the increasing presence of carbon dioxide in the atmosphere, oil and gas operators have looked to carbon capture and storage as a solution for aiding in the removal or reduction in greenhouse gas emissions and thus aiding in the mitigation of climate change. Carbon capture and storage requires the injection of carbon dioxide in a subsurface reservoir. To ensure the safe and reliable injection of carbon dioxide into subsurface reservoirs, the volume of the injected carbon dioxide and the further propagation of carbon dioxide in the subsurface must be predicted. Predictions of carbon dioxide volumes and subsurface propagation may be calculated by numerical methods or analytical methods. Numerical methods may require a significant quantity of data, manpower, and computing resources.

One possible solution may be to utilize analytical methods to predict volumes of carbon dioxide injection and subsurface propagation of carbon dioxide, which may require a more simplified approach with fewer inputs. The analytical methods may be implemented in any scientific programming language and may provide comparable results in less time than the numerical methods. The analytical methods may provide a simple estimation of the volume and movement of the injected carbon dioxide in the subsurface.

Proposed herein is a workflow to estimate the size of the injected CO2 in the subsurface. Embodiments disclosed herein estimate how large the impact of the injected CO2 is in the subsurface, and this information can be used to assess the validity of a potential site.

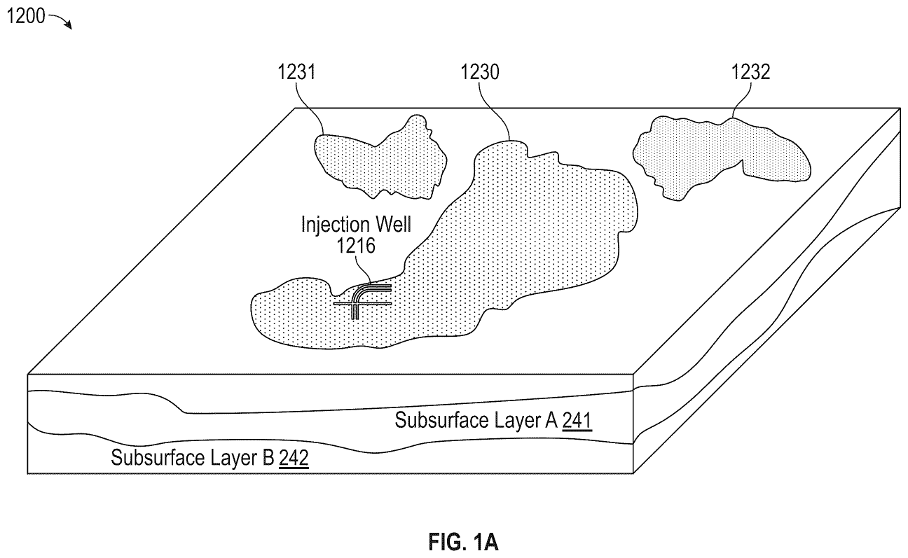

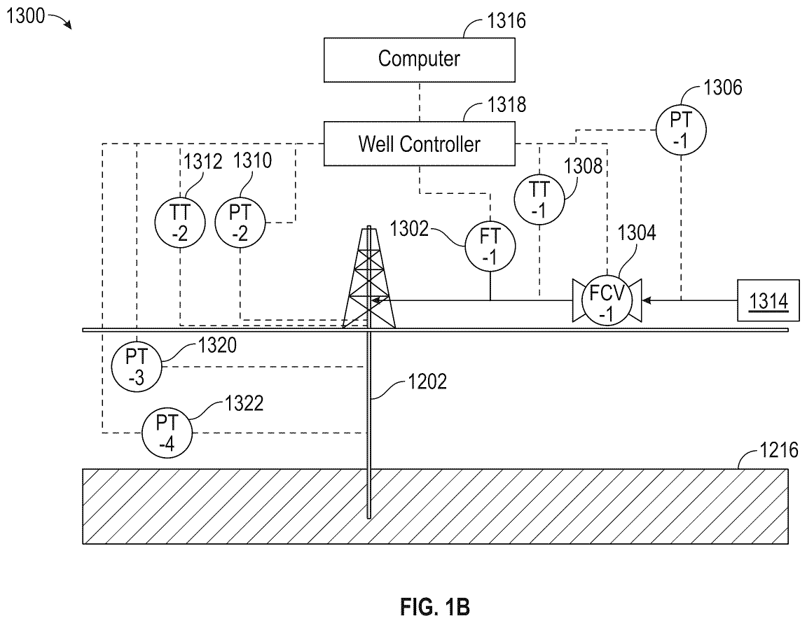

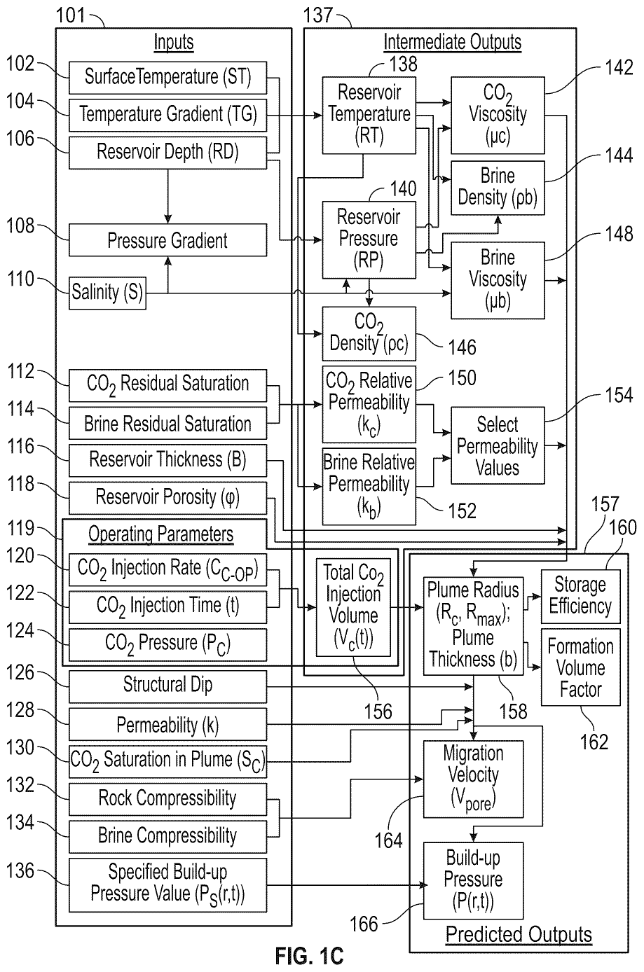

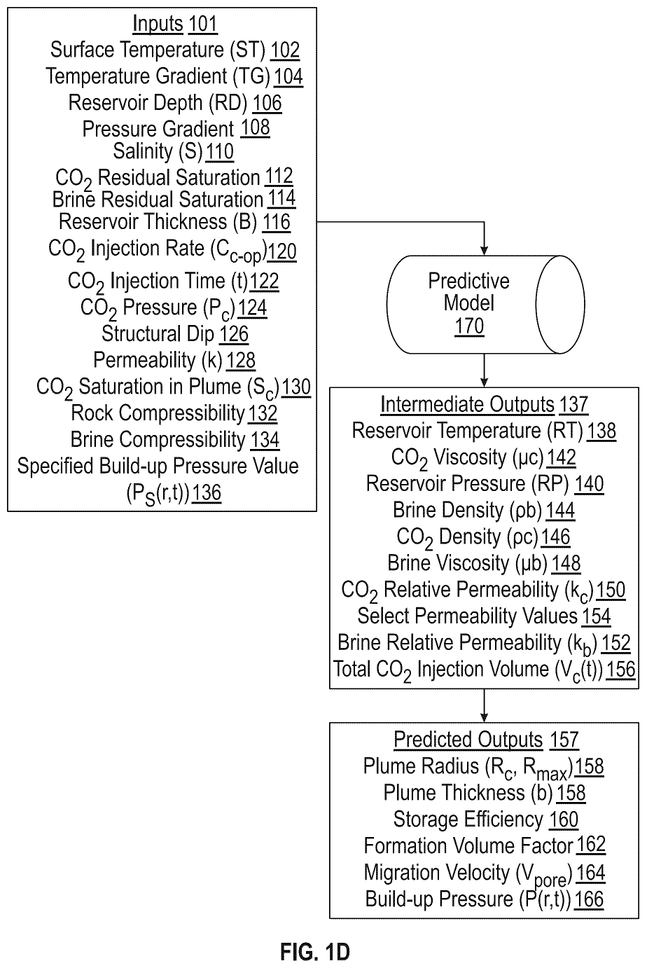

In the following description of FIGS. 1A-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure include systems and methods for carbon capture and storage. The workflow presented in embodiments disclosed herein prepares the inputs required for the analytical calculation of several parameters required for subsurface carbon storage assessment. The inputs represent the subsurface conditions of the reservoir where the carbon dioxide will be stored, including various pressures and temperatures. The results include maximum and dry carbon dioxide plume radius and shape (plume thickness), storage efficiency, formation volume factor, migration velocity and the build-up pressure after the carbon dioxide injection. The objective is to prepare the inputs for a reservoir at a given depth, temperature, and pressure to ensure that all other necessary inputs reflect the pressure and temperature regime.

Carbon capture and storage may aid in removing or reducing greenhouse gas emissions. The carbon dioxide may be captured from large emission point sources such as a chemical plants or power plants, collected, and stored deep in geological formations, either to slowly dissipate into the formation or to form in mineral carbonates.

In accordance with one or more embodiments, the inputs and the operating parameters may be obtained by and accumulated/stored in a computer to produce a predictive model that in one or more embodiments is an analytical model that stores a plurality of equations forming relationships to get from the inputs to the predicted outputs, and thus determines a total carbon dioxide injection volume (V_{c}(t)). The computer may automatically adjust the set of operating parameters based on the predictive model and a well controller may control wellsite devices required for the injection of carbon dioxide into the well.

In one or more embodiments, the injection of carbon dioxide is predicted by a carbon dioxide injection system that uses a predictive model, based at least in part on a set of inputs reflecting the reservoir conditions and operating parameters for injecting carbon dioxide. The set of inputs may include surface temperature, temperature gradient, reservoir depth, pressure gradient, salinity, carbon dioxide residual saturation, brine residual saturation, reservoir thickness, reservoir porosity, carbon dioxide injection rate, structural dip, permeability, carbon dioxide saturation in plume, rock compressibility, brine compressibility, and specified build-up pressure value. The set of operating parameters may include carbon dioxide pressure, carbon dioxide injection rate, carbon dioxide injection time, and total carbon dioxide injection volume (V_{c}(t)). The set of operating parameters may be determined by one or more predictive outputs including plume radius, storage efficiency, formation volume factor, migration velocity, and build-up pressure. The predictive outputs may depend in whole or in part on one or more intermediate outputs including reservoir temperature, pressure gradient, reservoir pressure, carbon dioxide viscosity, brine density, brine viscosity, carbon dioxide density, relative permeability, and permeability values. In one or more embodiments, the predictive outputs are used to assess the validity of a potential site for injecting and storing carbon dioxide. One or more potential sites may be assessed to select a validated site where an injection well is drilled into subsurface layers to inject carbon dioxide for storage.

FIG. 1A shows a schematic diagram in accordance with one or more embodiments. As illustrated in FIG. 1A, FIG. 1A shows a geological region (1200) that may include one or more reservoir sites (e.g., reservoir site (1230), reservoir site (1231), reservoir site (1232)) disposed above various subsurface layers (e.g., subsurface layer A (241), subsurface layer B (242)), which may include saline formations, oil and natural gas reservoirs, unmineable coal seams, organic-rich shales, basalt formations, sedimentary layers, impermeable layers, etc.

Carbon dioxide (CO₂) can be stored underground as a supercritical fluid at a temperature in excess of 31.1° C. (88° F.) and a pressure in excess of 72.9 atm (about 1,057 psi), which define the critical point for CO₂. At such high temperatures and pressures, the CO₂ is dense like a liquid but has viscosity like a gas. The required storage volume of CO₂ in the supercritical condition is substantially less than if the CO₂ were stored at temperature-pressure conditions at the Earth's surface.

Temperature naturally increases with depth in the Earth's crust, as does the pressure of the fluids (brine, oil, or gas) in the formations. At depths below about 800 meters (about 2,600 feet), the natural temperature and fluid pressures are in excess of the critical point of CO₂ for most places on Earth such that the CO₂ injected at this depth or deeper remains in the supercritical condition. The CO₂ remains underground based on various mechanisms, such as structural trapping, residual trapping, solubility trapping, or mineral trapping. Structural trapping is the physical trapping of CO₂ in the rocks and faults that act as seals, preventing CO₂ from moving out of the storage formation. Residual trapping refers to the CO₂ that remains trapped in the pore space between the rock grains as the CO₂ plume migrates through the rock. In solubility trapping, a portion of the injected CO₂ dissolves into the brine water in the pore spaces within the rocks. Mineral trapping refers to a reaction that occurs when the CO₂ dissolved in the rock's brine water reacts with the minerals in the rocks.

As shown in FIG. 1A, an injection well (1216) exists that penetrates the subsurface layers to reach an underground reservoir at the reservoir site (1230). For example, the underground reservoir may be suitable for CO₂ storage. In one or more embodiments, the injection well (1216) is part of a carbon dioxide injection system that may be similar to the carbon dioxide injection system (1300) described in reference to FIG. 1B below. The carbon dioxide injection system and the underground reservoir at the reservoir site (1230) collectively form a carbon dioxide storage system.

FIG. 1B shows a schematic diagram in accordance with one or more embodiments. More specifically, FIG. 1B illustrates a carbon dioxide injection system (1300) including an injection well, e.g., the injection well (1216) located at the reservoir site (1230) depicted in FIG. 1A above. The carbon dioxide injection operation of the well (1202) may be defined by a set of operating parameters including but not limited to carbon dioxide injection rate (C_{c-op}) carbon dioxide injection time (t), and carbon dioxide pressure (P_{c}), and total carbon dioxide injection volume (V(t)).

A plurality of wellsite devices disposed at the well (1202) may include a carbon dioxide flow transmitter FT-1 (1302), flow control valve of carbon dioxide FCV-1 (1304), carbon dioxide injection pressure transmitter PT-1 (1306), carbon dioxide injection temperature transmitter TT-1 (1308), surface pressure transmitter PT-2 (1310), first downhole pressure transmitter PT-3 (1320), second downhole pressure transmitter PT-4 (1322), and surface temperature transmitter TT-2 (1312). The plurality of wellsite devices may gather a set of inputs including temperatures, pressures, and flow data and transmit that data to a well controller (1318). The well controller (1318) may be a Programmable Logic Controller (PLC) and may control the FCV-1 (1304) to open or close based on a targeted carbon dioxide injection rate (C_{c}) and the transmitted value from FT-1 (1302). Carbon dioxide temperature transmitter TT-1 (1308) may be utilized to measure the temperature downstream of the carbon dioxide flow control valve FCV-1 (1304) to ensure the temperature remains within the design limits of the pipe feeding the well downstream of the pressure drop caused by FCV-1 (1304). For example, if the pressure drop across FCV-1 (1304) is high enough, the Joule-Thomson effect of rapid cooling may occur on the pipe material. The carbon dioxide pressure transmitter PT-1 (1306) may transmit the pressure of the incoming carbon dioxide to the carbon dioxide injection system. The transmitted value of pressure from PT-1 (1306) may be sent to the well controller, which may control the FVC-1 (1304) to close or open depending on the incoming pressure and the pressure rating of the piping and equipment throughout the carbon dioxide injection system.

In order to determine the pressure gradient as part of the set of inputs, the carbon dioxide injection system requires various pressure transmitters staged throughout the length of the well including a surface pressure transmitter PT-2 (1310), a first downhole pressure transmitter PT-3 (1320), and a second downhole pressure transmitter (1322). Although there are only three pressure transmitters mentioned with regard to the calculation of the pressure gradient and only two downhole pressure transmitters showing on FIG. 1B, one skilled in the art would know that a larger or smaller number may be required to determine a pressure gradient. Finally, the carbon dioxide injection system may include in the plurality of wellsite devices, a surface temperature transmitter TT-2 (1312) that may be used to determine the surface temperature (ST) required as part of the set of inputs.

The carbon dioxide injection system may include a computer (1316). For example, the computer (1316) may include hardware and/or software with functionality for generating one or more reservoir models and perform numerical simulations or analytical computations regarding the subsurface, e.g., to validate potential sites for carbon dioxide storage. In one or more embodiments, the reservoir model is a numerical model that includes a set of partial differential equations representing reservoir and well flows that are solved numerically. Numerical solution involves time and space/domain discretization replacing differential equations with difference equations. Time discretization refers to division of time into a sequence of time steps. In each time step, after discretization is solved iteratively, a non-linear system is linearized using Newton method, which may take several Newton iterations to converge. Space/domain discretization, also called grid generation, refers to division of the reservoir domain into a reservoir grid of small grid blocks. A grid is a tessellation of a set of contiguous polygonal (2D) or polyhedral (3D) objects referred to as grid blocks/cells/elements/control volumes. The grid generation is a process of discretization of the reservoir using both structured and more complex unstructured grid blocks to accurately represent the geometry of the reservoir.

Numerical schemes used in reservoir simulation are control volume distributed (CVD). Rock properties such as permeability and porosity, and flow properties such as pressure, temperature, and composition (saturation) are assumed piecewise constant within a control volume (i.e., grid block). However, reservoir and flow properties may jump by order of magnitude across the faces of the control volumes (i.e., grid blocks). Consequently, property distribution in reservoir simulation is stair step, and rate of change of a property across grid blocks depends on grid resolution. Lack of definition within a single grid block and sharp changes in pressure and saturation across the grid blocks create several physical, numerical, and convergence problems during the reservoir simulation.

In one or more embodiments, the reservoir model is an analytical model that uses a set of mathematical equations to directly compute the modeling results without solving any differential equations based on numerical techniques such as discretization and Newton iterations of the numerical model described above. Using the analytical model, the modeling results can be generated expediently to validate potential sites for carbon dioxide storage without any of the physical, numerical, and convergence problems associated with the numerical models. In such embodiments using the analytical model, the computer (1316) is configured to obtain the inputs including the temperatures, pressures, and flow data collected by 1302, 1304, 1306, 1308, 310, and 1312. The computer (1316) may be configured to obtain the operating parameters for the well provided by the well controller including the carbon dioxide injection rate (C_{c-op}), carbon dioxide injection time (t), carbon dioxide injection pressure (P_{c}), and total carbon dioxide injection volume (V_{c}(t)). The computer (1316) may be configured to obtain a set of inputs from the well and accumulate a volume of data processed in a defined time to produce a predictive model. The volume of data may include accumulated inputs, including but not limited to surface temperature (ST), temperature gradient (TG), reservoir depth (RD), pressure gradient, salinity (S), carbon dioxide residual saturation, brine residual saturation, reservoir thickness (B), reservoir porosity (φ), carbon dioxide injection rate (C_{c-op}), structural dip, permeability (k), carbon dioxide saturation in plume (S_{c}), rock compressibility, brine compressibility, and specified build-up pressure value (Pₛ(r, t)). All of this data may be input for computation of intermediate outputs including reservoir temperature (RT), reservoir pressure (RP), carbon dioxide viscosity (μ_{c}), brine viscosity (μ_{b}), brine density (ρ_{b}), carbon dioxide density (ρ_{c}), relative permeability (k_{c}, k_{b}), and total carbon dioxide injection volume (V_{c}(t)) in order to produce a predictive model. Together, the inputs and the intermediate outputs may be utilized in a predictive model to determine predictive outputs including plume radius (R_{c}, Rₘₐₓ), plume thickness, storage efficiency, formation volume factor, migration velocity (Vₚₒᵣₑ), and build-up pressure (P(r, t)). In one or more embodiments, the predictive model may be used to determine predictive outputs for additional reservoir sites without any existing wells, such as reservoir sites (1231, 1232) described in reference to FIG. 1A above. As noted above, the reservoir sites (1231, 1232) may be assessed to select a validated site (e.g., reservoir site (1231)) where an additional injection well may be drilled to inject carbon dioxide for storage.

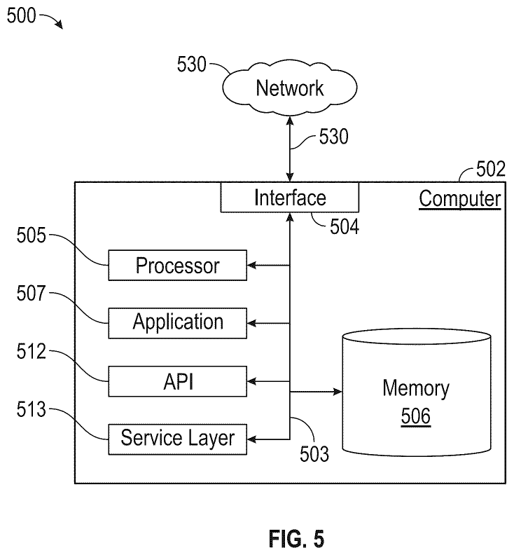

Finally, the computer (1316) may adjust the set of operating parameters including injection rate (C_{c}), injection time (t), and total carbon dioxide injection volume (V_{c}(t)) based on the predictive model. In one or more embodiments, the predictive model is an analytical model similar to the predictive model (170) described in reference to FIGS. 1C-1D below. While the computer (1316) is shown at a well site, embodiments are contemplated where the computer (1316) is located away from well sites. In some embodiments, the computer (1316) may include a computer system that is similar to the computer system (500) described below with regard to FIG. 5 and the accompanying description.

FIGS. 1C and 1D show schematic diagrams in accordance with one or more embodiments, depicting the relationship between inputs (101), intermediate outputs (137), and predicted outputs (157). More specifically, the FIGS. 1C-1D illustrate a predictive model (170) as an analytical model that stores a plurality of equations forming relationships to get from the inputs to the predicted outputs. In one or more embodiments, FIG. 1C shows various inputs which may include field data, operating parameters (119), and other calculated values which are used by the predictive model (170) to analytically determine intermediate outputs (137), which lead ultimately to predicted outputs (157) which are used to validate potential site selection for CO₂ storage.

The inputs of FIG. 1C may include surface temperature (102), temperature gradient (TG) (104), reservoir depth (RD) (106), salinity (S) (110), carbon dioxide residual saturation (112), brine residual saturation (114), reservoir thickness (B) (116), reservoir porosity (φ) (118), and carbon dioxide injection rate (C_{c-op}) (120), carbon dioxide injection time (t) (122), carbon dioxide injection pressure (P_{c}) (124), structural dip (126), permeability (k) (128), carbon dioxide saturation in plume (S_{c}) (130), rock compressibility (132), brine compressibility (134), and specified build-up pressure value (Pₛ(r, t)) (136).

In addition, FIG. 1C illustrates a set of intermediate outputs which may include reservoir temperature (RT) (138), reservoir pressure (RP) (140), carbon dioxide viscosity (Uc) (142), brine density (ρ_{b}) (144), brine viscosity (μ_{b}) (148), carbon dioxide density (ρ_{c}) (146), relative permeabilities (k_{c}, k_{b}) (150, 152), select permeability values (154), and total carbon dioxide injection volume (V_{c}(t)) (156). Finally, FIG. 1C also illustrates one or more predicted outputs, which may include plume radius (R_{c}, Rₘₐₓ) (158), storage efficiency (160), formation volume factor (162), migration velocity (Vₚₒᵣₑ) (164), and build-up pressure (P(r,t)) (166). Generally, the set inputs may at least in part be required to calculate the intermediate outputs, and the intermediate outputs may at least in part be required to calculate the predicted outputs.

Included in the set of inputs of FIG. 1C, the surface temperature (ST) (102) may be determined from a temperature sensing element located at the surface of the well, either at the wellhead or at an elevation equivalent to grade. The sensed surface temperature may be collected and sent via a transmitter to a computer for analysis. The surface temperature may be measured in degrees centigrade or Fahrenheit and converted into the proper units as input (101) to a predictive model.

The temperature gradient (TG) (104) is a physical quantity describing directionally and locationally a rate of temperature change. The temperature gradient may be determined with temperatures sensed by one or more temperature sensors disposed along the length of a well in the same manner as the surface temperature. Therefore, the temperature gradient may measure a temperature difference per unit length for a vertical well and is a vector quantity. To measure a temperature gradient in a reservoir site without a well, surface-based geophysical methods or other estimation methods may be used.

The reservoir depth (RD) (106) is a measurement of the depth of the reservoir made during either the drilling phase of a well or later during a well logging activity.

Turning to the intermediate outputs of FIG. 1C, reservoir temperature (RT) (138) may be calculated using surface temperature (ST) (102) measured in degrees centigrade (° C.), temperature gradient (TG) (104) measured in degrees centigrade per kilometer (° C./km), and reservoir depth (RD) (106) measured in meters (m). RT (138) is measured in degrees centigrade (° C.) and may be calculated as below:

$$RT = \frac{RD \times TG}{1000} + ST \qquad ( 1 )$$

Included in the set of inputs, the salinity (S) (110), measured in parts per million by either weight (ppm-w) or volume (ppm-v), which is the salt content in the well. The formulas do not require distinction between ppm-w or ppm-v. S may be determined by sampling the formation water from the reservoir and testing it, or by centrifuging free water out of conventional core cut with oil-based mud. Alternatively, if formation water is not available for analysis, estimates of salinity utilizing pressure data from the reservoir to determine density may be used. From density, an estimate of salinity may be used.

Included in the set of inputs, pressure gradient (108) is a physical quantity describing directionally and locationally a rate of pressure change. The pressure gradient (108) may be determined with pressures sensed by one or more pressure sensors disposed along the length of a well and transmitted to a well controller and stored in a computer. Therefore, the pressure gradient (108) may measure a pressure difference per unit length for a vertical well. Pressure gradient (108) is a vector quantity. In some embodiments, reservoir depth (RD) (106) and S (110) may be used to determine pressure gradient, while in others, they may be determined as described above by measurement. To measure a pressure gradient in a reservoir site without a well, shale logging data cross plots are constructed to relate pressure gradient to sonic travel time difference or resistivity ratio.

Included in the intermediate outputs, reservoir pressure (RP) (140) may be measured in pounds per square inch absolute (psia) and may be calculated by RD (106) and S (110). RP (140) may be calculated in the equation below, where RD (106) is measured in feet (ft) and S is measured in parts per million (ppm):

$$RP = RD \times ( 1 + S \times 0.0000006 \; 95 ) \times 0.0361273 \times 12 + 14.7 \qquad ( 2 )$$

Included in the intermediate outputs, RT (138) and RP (140) may be used to calculate carbon dioxide density (ρ_{c}) (146), which may be calculated as below, where ρ_{c} is in kilogram per cubic meter (kg/m³) and RP is in pounds per square inch absolute (psia):

$${ρ}_{c} = {A}_{0} + {A}_{1} RP + {A}_{2} {RP}^{2} + {A}_{3} {RP}^{3} + {A}_{4} {RP}^{4} \qquad ( 3 )$$

A₀, A₁, A₂, A₃, and A₄ are correlation coefficients associated with a temperature in Celsius (° C.), and calculated as below:

$${A}_{i} = {b}_{i 0} + {b}_{i 1} RT + {b}_{i 2} {RT}^{2} + {b}_{i 3} {RT}^{3} + {b}_{i 4} {RT}^{4} ( i = 0 , 1 , 2 , 3 , 4 ) \qquad ( 4 )$$

The values of bᵢⱼ may be listed as coefficients below for different pressure ranges:

Value of bᵢⱼ for coefficients in equation for Aᵢ above for pressure <3000 psia.

| | bᵢ₀ | bᵢ₁ | bᵢ₂ | bᵢ₃ | bᵢ₄ |
|---|---|---|---|---|---|
| i = 0 | −2.148322085348E+05 | 1.168116599408E+04 | −2.302236659392E+02 | 1.967428940167E+00 | −6.184842764145E−03 |
| i = 1 | 4.757146002428E+02 | −2.619250287624E+01 | 5.215134206837E−01 | −4.494511089838E−03 | 1.423058795982E−05 |
| i = 2 | −3.713900186613E−01 | 2.072488876536E−02 | −4.169082831078E−04 | 3.622975674137E−06 | −1.155050860329E−08 |
| i = 3 | 1.228907393482E−04 | −6.930063746226E−06 | 1.406317206628E−07 | −1.230995287169E−09 | 3.948417428040E−12 |
| i = 4 | −1.466408011784E−08 | 8.338008651366E−10 | −1.704242447194E−11 | 1.500878861807E−13 | −4.838826574173E−16 |

Value of bᵢⱼ for coefficients in equation for Aᵢ above for pressure >3000 psia.

| | bᵢ₀ | bᵢ₁ | bᵢ₂ | bᵢ₃ | bᵢ₄ |
|---|---|---|---|---|---|
| i = 0 | 6.897382693936E+02 | 2.730479206931E+00 | −2.254102364542E−02 | −4.651196146917E−03 | 3.439702234956E−05 |
| i = 1 | 2.213692462613E−01 | −6.547268255814E−03 | 5.982258882656E−05 | 2.274997412526E−06 | −1.888361337660E−08 |
| i = 2 | −5.118724890479E−05 | 2.019697017603E−06 | −2.311332097185E−08 | −4.079557404679E−10 | 3.893599641874E−12 |
| i = 3 | 5.517971126745E−09 | −2.415814703211E−10 | 3.121603486524E−12 | 3.171271084870E−14 | −3.560785550401E−16 |
| i = 4 | −2.184152941323E−13 | 1.010703706059E−14 | −1.406620681883E−16 | −8.957731136447E−19 | 1.215810469539E−20 |

Reservoir temperature (RT) (138) and reservoir pressure (RP) (140) may be used to calculate carbon dioxide viscosity (μ_{c}), which may be calculated as below, where viscosity (μ) is in centipoises (cP) and RP is in pressure per square inch absolute (psia):

$${μ}_{c} = {C}_{0} + {C}_{1} RP + {C}_{2} {RP}^{2} + {C}_{3} {RP}^{3} + {C}_{4} {RP}^{4} \qquad ( 5 )$$

The correlation coefficients C₀, C₁, C₂, C₃, and C₄ are calculated below in the following equation, where RT is in Celsius (° C.):

$${C}_{i} = {d}_{i 0} + {d}_{i 1} RT + {d}_{i 2} {RT}^{2} + {d}_{i 3} {RT}^{3} + {d}_{i 4} {RT}^{4} , \qquad ( 6 )$$

$$where$$

$$i = 0 , 1 , 2 , 3 , 4$$

The correlation coefficients dᵢⱼ where i=0, 1, 2, 3, 4 and j=0, 1, 2, 3, 4 are listed below for a RP of less than 3,000 psia and a pressure greater than 3,000 psia:

Value of dᵢⱼ for coefficients in equation for Cᵢ above for an RP<3000 psia.

| | dᵢ₀ | dᵢ₁ | dᵢ₂ | dᵢ₃ | dᵢ₄ |
|---|---|---|---|---|---|
| i = 0 | −1.958098980443E+01 | 1.123243298270E+00 | −2.320378874100E−02 | 2.067060943050E−04 | −6.740205984528E−07 |
| i = 1 | 4.187280585109E−02 | −2.425666731623E−03 | 5.051177210444E−05 | −4.527585394282E−07 | 1.483580144144E−09 |
| i = 2 | −3.164424775231E−05 | 1.853493293079E−06 | −3.892243662924E−08 | 3.511599795831E−10 | −1.156613338683E−12 |
| i = 3 | 1.018084854204E−08 | −6.013995738056E−10 | 1.271924622771E−11 | −1.154170663233E−13 | 3.819260251596E−16 |
| i = 4 | −1.185834697489E−12 | 7.052301533772E−14 | −1.500321307714E−15 | 1.368104294236E−17 | −4.545472651918E−20 |

Value of dᵢⱼ for coefficients in equation for Cᵢ above for RP >3000 psia.

| | dᵢ₀ | dᵢ₁ | dᵢ₂ | dᵢ₃ | dᵢ₄ |
|---|---|---|---|---|---|
| i = 0 | 1.856798626054E−02 | 3.083186834281E−03 | −1.004022090988E−04 | 8.331453343531E−07 | −1.824126204417E−09 |
| i = 1 | 6.519276827948E−05 | −3.174897980949E−06 | 7.524167185714E−08 | −6.141534284471E−10 | −1.463896995503E−12 |
| i = 2 | −1.310632653461E−08 | 7.702474418324E−10 | −1.830098887313E−11 | 1.530419648245E−13 | −3.852361658746E−16 |
| i = 3 | 1.335772487425E−12 | −8.113168443709E−14 | 1.921794651400E−15 | −1.632868926659E−17 | 4.257160059035E−20 |
| i = 4 | −5.047795395464E−17 | 3.115707980951E−18 | −7.370406590957E−20 | 6.333570782917E−22 | −1.691344581198E−24 |

In one or more embodiments, RT (138) and RP (140) may be used to calculate brine density (ρ_{b}), which depends on the density of water (ρ_{H2O}) and the dissolved solute fraction, or the salinity (S) measured in weight-ppm (ppm-w):

$${ρ}_{H 2 O} = 1 + 1 \times 1 {0}^{- 6} ( - 80 RT - 3.3 {RT}^{2} + 0.00 \; 175 {RT}^{3} + 489 RP - 2 RT \times RP + 0.0 \; 16 {RT}^{2} RP - 1.3 \times 1 {0}^{- 5} {RT}^{3} RP - 0.3 \; 33 {RP}^{2} - 0.0 \; 02 RT \times {RP}^{2} \qquad ( 7 )$$

$${ρ}_{b} = {ρ}_{H 2 O} + \frac{S}{1 , 000 , 000} \{ 0.668 + 0 \text{.44} \frac{S}{1 , 000 , 000} + 1 \times 1 {0}^{- 6} [ 300 RP - 2400 RP \times \frac{S}{1 , 000 , 000} + RT ( 80 + 3 RT - 3 \; 300 \frac{S}{1 , 000 , 000} - 13 RP + 47 RP \times \frac{S}{1 , 000 , 000} ) ] \} \qquad ( 8 )$$

Continuing with the intermediate outputs of FIG. 1C, brine viscosity (μ_{b}) (148) may be calculated from RT (138), S (110) converted to molality (M), and ρ_{H2O}:

$${μ}_{b} = {μ}_{H 2 O} \times {e}^{AXM + {BXM}^{2} + {CXM}^{3}} \qquad ( 9 )$$

The equation for brine viscosity (μ_{b}) (144) above requires calculation of M and the A, B, and C parameters:

$$M = \frac{S}{1 \text{,0} 00} X 58 \text{.44} \qquad ( 10 )$$

$$A = {a}_{0} + {a}_{1} RT + {a}_{2} {RT}^{2} \qquad ( 11 )$$

$$B = {b}_{0} + {b}_{1} RT + {b}_{2} {RT}^{2} \qquad ( 12 )$$

$$C = {c}_{0} + {c}_{1} RT \qquad ( 13 )$$

| Parameters | aₒ | a₁ | a₂ | bₒ | b₁ |
|---|---|---|---|---|---|
| Brine | −0.21319213 | 0.13651589 × 10⁻² | −0.12191756 × 10⁻⁵ | 0.69161945 × 10⁻¹ | −0.27292263 × 10⁻³ |

| Parameters | b₂ | c₀ | c₁ |
|---|---|---|---|
| Brine | 0.20852448 × 10⁻⁶ | −0.25988855 × 10⁻² | 0.77989227 × 10⁻⁵ |

In the set of inputs, carbon dioxide residual saturation is defined as the carbon dioxide trapped in the pores of the rock. Carbon dioxide residual saturation (112) may be determined by removing either a core sample or a produced water sample and measuring the volume of carbon dioxide evolving from the sample relative to the other components in the sample. If a rock core is not available, then one skilled in the art would know that an estimate may be made from the porosity and permeability of the rock, and that values usually range from 5 to 30%. With respect to the core sample, the residual saturation of carbon dioxide (112) may be the volume fraction of the pore space in the reservoir occupied by carbon dioxide. With respect to the water sample, the residual saturation of carbon dioxide (112) may be the volume of carbon dioxide evolved from the water sample relative to any hydrocarbons or water.

Continuing with FIG. 1C, brine residual saturation (114) may be determined by removing a core sample and measuring the volume of brine trapped in the core sample relative to other components in the sample.

Carbon dioxide relative permeability and the brine relative permeability may be calculated from the set of inputs including carbon dioxide residual saturation (112) and brine residual saturation (114). The carbon dioxide relative permeability (150) may be calculated as follows, where k_{b} is brine relative permeability (unitless) (152) and k_{c} is carbon dioxide relative permeability (unitless) (150). Pertaining to both k_{b} and k_{c},

$${S}_{b}^{irr}$$

is brine irreducible saturation and is defined as the lowest brine saturation achievable by displacing brine from the reservoir by injecting carbon dioxide. At this level of saturation, brine is no longer mobile, and the brine saturation is the lowest possible even if more carbon dioxide is injected into the well. Further, S_{CO2} is actual carbon dioxide saturation and

$${S}_{CO 2}^{C}$$

is critical carbon dioxide saturation and for purposes of this disclosure is treated as

$${S}_{CO 2}^{C} = 0.$$

### Pertaining to k_{b},

$${k}_{rb}^{max} = 1$$

and is maximum brine relative permeability.

$${k}_{b} = {k}_{b}^{max} \times {( \frac{1 - {S}_{c} - {S}_{b}^{irr}}{1 - {S}_{{CO}_{2}}^{C} - {S}_{b}^{irr}} )}^{m} \qquad ( 14 )$$

k_{c}^{max} is maximum carbon dioxide relative permeability.

$${k}_{c} = {k}_{c}^{max} \times {( \frac{{S}_{c} - {S}_{{CO}_{2}}^{c}}{1 - {S}_{{CO}_{2}}^{C} - {S}_{b}^{irr}} )}^{n} \qquad ( 15 )$$

In one or more embodiments, instead of calculating the carbon dioxide relative permeability (150) and the brine relative permeability (152), k_{c} and k_{b}, select permeability values (154) may include a carbon dioxide relative permeability value of k_{c}=0.95 and a brine relative permeability value of k_{b}=0.5.

Still keeping with FIG. 1C, reservoir thickness (B) (116), measured in meters (m) may be measured in the direction normal to the reservoir surface, regardless of the geometry or orientation of the reservoir. Reservoir thickness may also be defined as the vertical distance from the top to the bottom of the reservoir. Reservoir thickness (116) may be measured utilizing seismic technology known to persons of ordinary skill in the art.

In the set of inputs, reservoir porosity (φ) (118) is the characterization of pores and fractures of a reservoir. Reservoir porosity is unitless and defined as the ratio of void space (pore volume) to bulk volume. Reservoir porosity may, among other methods, be measured using conventional logging data, core tests, and well logs. If in the alternative, the aforementioned data is not available, then empirical methods of estimating porosity may also suffice.

Included in the set of inputs are operating parameters, such as carbon dioxide injection rate (C_{c-op}) (120), which may be defined as the rate of volumetric injection of carbon dioxide into the well. Cₒ₋ₒₚ may be measured in cubic meters per second (m³/s) and may be measured at the injection point at the wellsite above-ground by means of a venturi meter, orifice plate, or ultrasonic flow meter.

In one or more embodiments, the set of inputs may include operating parameters, which may include carbon dioxide injection time (t) (112) measured in seconds(s), and carbon dioxide injection pressure (P_{c}) (124) measured in pounds per square inch absolute (psia). Both Cₒ₋ₒₚ (m³/s) (12) and t(s) (122) may be used to calculate the intermediate output (137) of total carbon dioxide injection volume, V_{c}(t) (156), in cubic meters (m³):

$${V}_{c} ( t ) = {C}_{c - op} \times t \qquad ( 16 )$$

Turning to the predicted outputs (157), maximum plume radius (Rₘₐₓ) and dry plume radius (R_{c}) (158) may be calculated using inputs including carbon dioxide viscosity (142), brine viscosity (148), carbon dioxide relative permeability (150), brine relative permeability (152), reservoir thickness (B) (116), reservoir porosity (φ) (118), and total carbon dioxide injection volume (V_{c}(t)) (156).

The plume radius may include both R_{c} and Rₘₐₓ. R_{c} may be defined as the radius in the carbon dioxide domain. Rₘₐₓ (158) may be defined as the radius in the brine domain 1 (λ_{b1}), which may be defined as the maximum radius (m) of the carbon dioxide plume at the bottom and top of the reservoir after injecting carbon dioxide for a certain time (t). Both the equations for R_{c} and Rₘₐₓ require individual phase mobility of brine in the brine domain 1 (λ_{b1}), individual phase mobility of the carbon dioxide in the carbon dioxide domain (λ_{c}), porosity (φ) (118), total reservoir thickness (B) (116), and total carbon dioxide injection volume (V_{c}(t)) (156). Individual phase mobility (λ_{α}) is defined as the ratio of the relative permeability to fluid viscosity λ_{α}=k_{α}/μ_{α} where the α subscript indicates the fluid (α=c for carbon dioxide, and α=b for brine). The equations for R_{c} and Rₘₐₓ (158) are listed below where R_{c} is the radius in the CO₂ domain and Rₘₐₓ is the radius in brine domain, which is the maximum extent of the CO₂ plume.

$${R}_{c} = \sqrt{\frac{{λ}_{b 1} {V}_{c} ( t )}{{λ}_{c} φ π B}} \qquad ( 17 )$$

$${R}_{max} = \sqrt{\frac{{λ}_{c} {V}_{c} ( t )}{{λ}_{b 1} φ π B}} \qquad ( 18 )$$

Included in the predicted outputs, plume thickness (b) (158) is a function of radial distance (r), time (t), individual phase mobility of the carbon dioxide in the carbon dioxide domain (λ_{c}), individual phase mobility of brine in the carbon dioxide domain (λ_{b}), total carbon dioxide injection volume (V(t)) (156), porosity (φ) (118), and may be expressed below:

$$\frac{b ( r , t )}{B} = \frac{1}{{λ}_{c} - {λ}_{b}} [ \sqrt{\frac{{λ}_{c} {λ}_{b} V ( t )}{φ π {Br}^{2}}} - {λ}_{b} ] \qquad ( 19 )$$

Included in the predicted outputs, storage efficiency (160) may be calculated using the plume radius equation (158), where V_{c}(t) is the carbon dioxide injection rate at the end of time t (m³/s), porosity (φ) (118), B is reservoir thickness (m) (116), and Rₘₐₓ (158) is the maximum plume radius at the end of injection (m):

$$Storage Efficiency = \frac{{V}_{c} ( t )}{φ B π {( {R}_{max} )}^{2}} \qquad ( 20 )$$

Included in the predicted outputs, formation volume factor (162) may be calculated using plume radius as below where the “volume at reservoir conditions” and the “volume at surface conditions” are calculated using the densities at surface and reservoir conditions, respectively. Formation factor represents the factor of volume reduction when carbon dioxide at the surface is injected into the reservoir for storage.

$$formation volume factor = \frac{carbon dioxide volume at reservoir conditions}{carbon dioxide volume at surface conditions} \qquad ( 21 )$$

Further in keeping with FIG. 1C, in the set of inputs, structural dip (126) is the inclination of the reservoir. Structural dip (126) is usually measured in degrees. The permeability (k) (128) includes both absolute permeability and relative permeability. Absolute permeability may be measured in darcy (d) or millidarcy (md) and is defined as a flow rate against a pressure gradient. Relative permeability, a dimensionless ratio ranging from 0 to 1, may be defined as the ability of a certain phase to move through a reservoir in comparison to that of a single-phase fluid such as water, or the effective permeability of the selected phase. For example, the relatively permeability of carbon dioxide, k_{c}, is the relative ability of carbon dioxide to move through a reservoir in comparison to water. Absolute permeability and/or relative permeability may be used in the calculation of migration velocity.

The set of inputs further includes the carbon dioxide saturation in a plume (S_{c}) (130), which is CO₂ saturation ranging from 0 to 1, the rock compressibility (132) measured in square meters per Newton (m²/N), and the brine compressibility (134) measured in square meters per Newton (m²/N). Both the rock compressibility (132) and the bring compressibility (134) are obtained from published measurements.

Together, carbon dioxide viscosity (μ_{c}) (142), brine density (ρ_{b}) (144), carbon dioxide density (ρ_{c}) (146), carbon dioxide relative permeability (k_{c}) (150), brine relative permeability (k_{b}) (152), reservoir porosity (φ) (118), absolute permeability (k) (128), carbon dioxide saturation in plume (S_{c}) (130) (an average value for the whole plume, usually 50%), and reservoir inclination (Θ) (126) are all factored into the predicted output of migration velocity Vₚₒᵣₑ (164), which may be illustrated by the equation below. In the equation below, k (128) and k_{c} (150) are measured in darcy (D), Δρ is the density differential between brine (ρ_{b}) (144) and CO₂ (ρ_{c}) (146) that is measured in pounds per square inch (psi), g is the gravitational acceleration (ft/s²), φ is unitless (118), S_{c} (130) is unitless and a percentage, μ_{c} (142) is measured in centipoise (cP), and Θ (126) is in radians or degrees:

$${V}_{pore} = \frac{u \times sin θ}{φ \times {S}_{c}} = \frac{k \times {k}_{c} \times Δ ρ \times g}{φ \times {S}_{c} \times {μ}_{c}} \times sin θ \qquad ( 22 )$$

Finally, the set of inputs includes the specified build-up pressure value (Pₛ(r, t)) (136), which may be defined by equipment design data, past field data including the historical pressure and flow profile of the well, the pressure rating of the wellsite equipment, and other operational factors. Once Pₛ(r, t) is specified, it may be factored into the equation for build-up pressure (P(r, t)), in order to obtain the predicted outputs (157).

FIG. 1C shows the predicted output of build-up pressure (166) which may be expressed by the equation P(r, t). The computation requires the mass flow of carbon dioxide or predicted injection rate (C_{c}) (168) measured in kilograms per second (kg/s), reservoir thickness (B) (116) measured in meters (m), absolute permeability (128) of the reservoir (k) measured in square meters (m²), density of the carbon dioxide fluid in the well at the depth of the reservoir (ρ_{c0}) measured in kilograms per cubic meter (kg/m³), individual phase mobility of the carbon dioxide in the carbon dioxide domain (λ_{c}) measured in meters-second per kilogram (m*s/kg), individual phase mobility of brine in the brine domain 1 (λ_{b1}), individual phase mobility of brine in the brine domain 2 (λ_{b2}), reservoir porosity (φ), maximum radius (m) of the carbon dioxide plume at the bottom and top of the reservoir after injecting carbon dioxide for a certain time t (R_{c} and Rₘₐₓ) (158), radius of the injection well (r_{well}) measured in meters (m), and the maximum radius (m) that flow influences in the reservoir (Rₒ), which occurs at the outer boundary.

The build-up pressure equation (166) also requires a computation of the individual phase mobility (λ_{α}) defined as the ratio of the relative permeability to fluid viscosity λ_{α}=k_{rα}/μ_{α} where the a subscript indicates the fluid (α=c for carbon dioxide, and α=b for brine). Finally, V_{c}(t) is the total carbon dioxide injection volume (156) into the reservoir (m³). In one or more embodiments, the build-up pressure (166) may be expressed as an explicit integral solution of two-phase flow P(r, t) between carbon dioxide and brine in the reservoir, where t is time measured in seconds(s), and r measured in meters (m) is the position in the reservoir at time t. The build-up pressure of any position within the reservoir, r (m), is defined below as P(r, t) below:

$$\text{} ( 23 )$$

$$P ( r , t ) = {P}_{0} + \{ \text{} \begin{matrix}\frac{{C}_{c}}{2 π {kB ρ}_{c 0}} [ \frac{1}{{λ}_{c}} ln \frac{{R}_{c}}{r} + ( \frac{1}{{λ}_{b 1}} - \frac{1}{{λ}_{c}} ) + \frac{1}{{λ}_{b 2}} ln \frac{{R}_{0}}{{R}_{max}} , & {r}_{well} \leq r < {R}_{c} \\ \frac{{C}_{c}}{2 π {kB ρ}_{c 0}} [ ( \frac{1}{{λ}_{b 1}} - \sqrt{\frac{φ π B}{{λ}_{c} {λ}_{b 1} {V}_{c} ( t )}} \times r ) + \frac{1}{{λ}_{b 2}} ln \frac{{R}_{0}}{{R}_{max}} ] , & {R}_{c} \leq r < {R}_{max} \\ \frac{{C}_{c}}{2 π {kB ρ}_{c 0}} [ \frac{1}{{λ}_{b 2}} ln \frac{{R}_{0}}{r} ] , & {R}_{max} \leq r < {R}_{0}\end{matrix}$$

$${R}_{0} = \sqrt{\frac{4 {Ttu}_{0}}{{u}^{*}}} + {R}_{max} = \sqrt{\frac{4 {u}_{0} kt}{μ φ ( {α}_{P} + {β}_{w} )}} + {R}_{max}$$

FIG. 1D illustrates a simplified flowchart of the predictive model (170) including all of the inputs (101), intermediate outputs (137), and predicted outputs (157). Inputs are fed to the predictive model (170), which computes both intermediate outputs and predicted outputs (157). The predictive model (170) may be an analytical engine that stores a plurality of equations used to calculate the intermediate and predicted outputs. Although not shown in FIG. 1D, several of the predicted outputs (157) require both the inputs (101) and the intermediate outputs (137) as inputs to the analytical equations.

In one or more embodiments, the specified build-up pressure (Pₛ(r, t)) (166) may be included in the set of inputs (101), and the build-up pressure equation (P(r, t)) may be used to solve for the predicted outputs (157) in all radial sections of the reservoir. Carbon dioxide injection rate (C_{c-op}) (120) is an operating parameter, as well as an input for plume radius (158). The predictive model may be operated such that the initial values of the operating parameters including carbon dioxide injection rate (C_{c-op}) (120) measured in volumetric flow rate, carbon dioxide injection time (t) (122), and subsequent total carbon dioxide injection volume (V_{c}(t)) (156) may be specified, and that therefore plume radius R_{c} and Rₘₐₓ may be calculated. The plume radius values may be input into P(r, t) (166), which in every radial section of the reservoir site (r_{well}≤r<R_{c}; R_{c}≤r<Rₘₐₓ; Rₘₐₓ≤r<R₀) is a function of at least Rₘₐₓ.

In one or more embodiments, the inputs (101), the intermediate outputs (137), and the predicted outputs (157) may be placed in the predictive model (170) and operated by any computer software. In one or more embodiments, P(r, t) (166) may be solved for a value of C_{c} (168), by performing one or more iterations that may lead to the convergence of the value of C_{c} directly factored into every radial section of the reservoir in P(r, t) and the value of Cₒ₋ₒₚ (120) that is an operating parameter included in the set of inputs (101). Once the value of C_{c} (168) is iterated until convergence is obtained, the value of C_{c} may be used to manipulate a well controller at a wellsite. Performance of this iteration may require basic conversion as Cₒ₋ₒₚ is in mass flow rate and C_{c} is in volumetric flow rate.

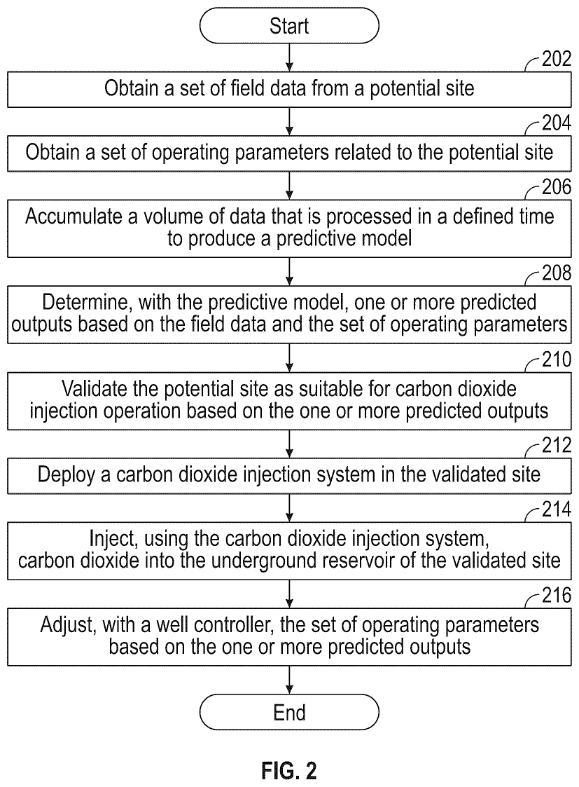

FIG. 2 shows a flowchart in accordance with one or more embodiments disclosed herein. One or more of the steps in FIG. 2 may be performed by the components of the geological region, carbon dioxide injection system, and the predictive model, discussed above in reference to FIGS. 1A-1D. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

As shown in FIG. 2, the flowchart corresponds to a method for carbon capture and storage (CCS). CCS is the separation and capture of carbon dioxide (CO₂) from the emissions of industrial processes prior to release into the atmosphere and storage of the CO₂ in deep underground geologic formations. CCS enables industry to continue to operate while emitting fewer greenhouse gases (CHGs) and addressing mitigation of anthropogenic CO₂ in the atmosphere. However, the CO₂ storage must be safe, environmentally sustainable, and cost-effective. In one or more embodiments, the method flowchart described below facilitates CSS by validating a potential site for storing CO₂ in a safe, environmentally sustainable, and cost-effective manner. In particular, the method steps include preparing the temperature and pressure inputs for an analytical model of CO₂ injection at a given depth to ensure that all other necessary inputs reflect the pressure and temperature regime of the underground CO₂ storage. Preparing the temperature and pressure inputs may include pressure and temperature corrections to ensure that CO₂ and water densities/viscosities are within the proper temperature and pressure regime for the calculations of the analytical model.

The method starts at step 202 with obtaining a set of inputs from a potential site, which may be performed by obtaining a set of inputs from wellsite devices and accumulating the set of inputs in a computer. The wellsite devices may include surface instruments and/or downhole devices. In one or more embodiments, the set of inputs include temperature and pressure at the surface, depth of an underground reservoir of the potential site, and temperature gradient and pressure gradient from the surface to the underground reservoir. The set of inputs may be measured or otherwise obtained using downhole devices in a well, such as an injection well, production well, or offset well. If no well exists in the potential site, surface-based geophysical methods or other estimation methods may be used.

Then, at step 204, the method obtains a set of operating parameters related to the potential site, which may be provided by the computer, and input by a user. Then, at step 206, the computer accumulates a volume of data that includes inputs (or a set of inputs) that is processed in a defined time to produce the predictive model. The predictive model may be run in any computer software that may be executed in the computer, or any external computer informationally connected to the computer such that commands may be transmitted as if the external computer were internal to the computer.

Next, at step 208, the method may determine, with the predictive model, one or more predicted outputs based on a set of inputs and a set of operating parameters, e.g., the one or more predicted outputs may include a predicted total carbon dioxide injection volume (V_{c}(t)), a predicted size of the resulting carbon dioxide plume, or a predicted pressure build-up (P(r, t)). The set of operating parameters may be used to automatically control the carbon dioxide injection rate (C_{c-OP}), carbon dioxide pressure (P_{c}), and total carbon dioxide injection volume (V_{c}(t)) of a carbon dioxide injection system. In one or more embodiments, the predicted outputs are generated using analytical equations of the predictive model without performing any numerical simulation using numerical techniques such as discretization, Newton iteration, etc. Using analytical model without numerical simulation avoids lengthy time delays and physical, numerical, and convergence problems associated with the numerical models such that the predicted outputs can be generated expediently. For example, the predicted size of the resulting carbon dioxide plume after injection may be determined expediently.

Next, at step 210, the potential site may be validated as suitable for carbon dioxide injection operation based on the one or more predicted outputs. In other words, the underground reservoir of the potential site is validated as suitable for carbon dioxide storage. For example, the potential site may be validated based on various criteria including the predicted outputs meeting or exceeding a target injection rate (C_{c}), a target total carbon dioxide injection volume (V_{c}(t)), a target size of the resulting carbon dioxide plume, or a minimum requirement of pressure build-up (P(r,t)). In one or more embodiments, the potential site is validated without performing any numerical model simulation of the potential site such that the validation can be generated expediently.

At step 212, a carbon dioxide injection system is deployed at the validate sited. In one more embodiments, a new injection well is drilled at the validated site and associated wellsite devices are installed, e.g., as depicted in FIG. 1B above. In an alternative scenario, well site devices are installed at an existing well of the validated site to complete the carbon dioxide injection system. For example, the existing well may be an injection well. In another example, the existing well may be an offset well or a production well that are retrofitted or otherwise modified into an injection well.

At step 214, the carbon dioxide may be injected into the underground reservoir of the validated site. The carbon dioxide may be delivered using the deployed carbon dioxide injection system and from a source of carbon dioxide through a pipeline network at a pressure within the design limits of the pipe. A carbon dioxide flow control valve may be operated according to a well controller to control the flow and pressure of the carbon dioxide as it flows into the injection well.

At step 216, the set of operating parameters may be adjusted with a well controller and a carbon dioxide injection system based on the one or more predicted outputs. Specifically, the well controller may adjust the carbon dioxide flow control valve to a value of a predicted injection rate generated by the predictive model.

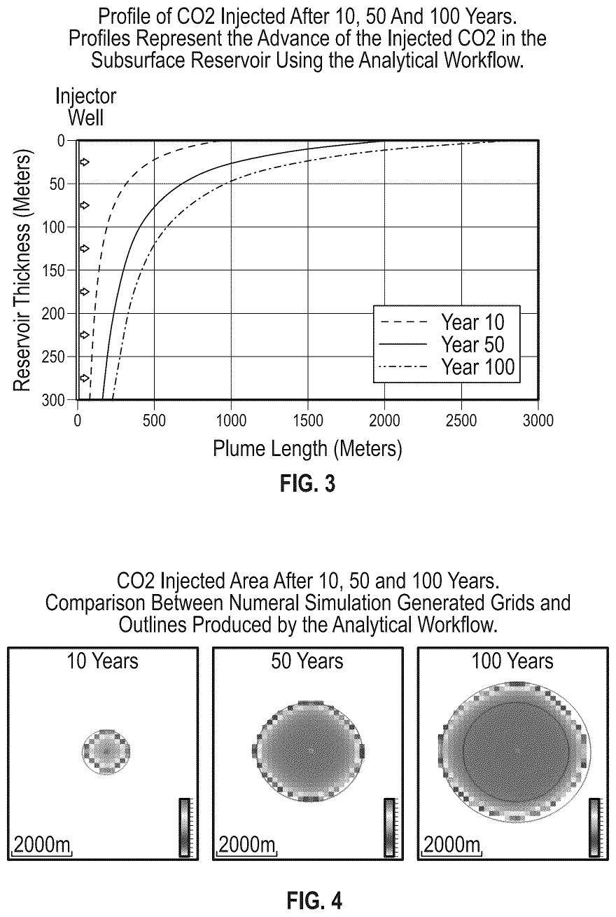

FIGS. 3-4 illustrates an example according to one or more embodiments disclosed herein. The example shown in FIGS. 3-4 is based on the system and method described in reference to FIGS. 1A-2 above. In particular, FIGS. 3-4 show example predicted outputs of a predictive model described in reference to FIGS. 1A-2 above. In one or more embodiments, one or more of the modules and/or elements shown in FIGS. 3-4 may be omitted, repeated, combined and/or substituted. Accordingly, embodiments disclosed herein should not be considered limited to the specific arrangements of modules and/or elements shown in FIGS. 3-4.

As shown in FIG. 3, FIG. 3 illustrates the predicted plume radius of a carbon dioxide injection site as generated using the analytic model as a function of reservoir thickness for three injection time duration of 10, 50, and 100 years. For example, the particular carbon dioxide injection site may be validated as suitable to the injection operation and carbon dioxide storage based on reaching a target storage volume corresponding to 250 meter, 500 meters, and 750 meters of plume radius at the depth of 50 meters by the 10^{th}, 50^{th}, and 100^{th} year of injection operation, respectively. In an example scenario where underground water exists at 700 meters from the injection well, the injection operation is to be terminated by 50^{th} year of injection operation to avoid contaminating the underground water resource.

As shown in FIG. 4, FIG. 4 illustrates a comparison of the predicted plume radius generated using the analytical model, illustrated in FIG. 3 above, with respect to highlighted grids generated using numerical simulations. As shown in FIG. 4, the results of the analytical model and numerical simulation match with each other without excessive discrepancy. In other words, using the analytical model as the predictive model to validate the carbon dioxide injection/storage site achieves the time expediency without excessive discrepancy from the result of the time consuming and resource intensive numerical simulation.

FIG. 5 shows a block diagram of a computer system (500) used to provide computational functionalities associated with described algorithms, methods, functions, processes, flows, and procedures of the predictive model (170) as described in the instant disclosure, according to one or more embodiments. For example, with respect to embodiments disclosed herein, the computer system (500) may run the analytical model and perform the required calculations discussed above. The illustrated computer system (500) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is typically physically adjacent to the process or control with which it interacts. For example, the predictive model may be implemented on an edge computing device in order to quickly provide optimal sets of gas-lift parameters to associated devices or their controllers.

Additionally, the computer system (500) may include a computer (502) that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (702). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or another suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504) includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer processor (505). Although illustrated as a single computer processor (505) in FIG. 5, two or more processors may be used according to particular needs, desires, or particular implementations of the computer (502). Generally, the computer processor (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). The memory may be a non-transitory computer-readable medium. For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), wherein each computer (502) communicates over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

The embodiments provided herein may lead to a faster, less cost-intensive method of predicting carbon dioxide optimal injection rates utilizing analytical methods compared to numerical methods. The embodiments provide a method and a system for predicting various parameters of subsurface carbon dioxide plumes formed from injection into a subsurface geological formation. The method requires a set of inputs, prepares intermediate outputs including the parameters of subsurface carbon dioxide storage that are required for the subsurface carbon dioxide storage assessment, and prepares predicted outputs required to inject carbon dioxide subsurface. If the results are positive, the process proceeds to site selection, filing of the required paperwork and potentially proceeds to drill a well. Without an estimate of the subsurface plume behavior, there cannot be a site selection.

The workflow of embodiments disclosed herein addresses the reservoir conditions and the amount of CO2 injected to predict how much of the subsurface will be occupied by the CO2. This has important implications, especially in the US, where industrial entities are required to demonstrate that the injected CO2 will remain in the permitted area. The workflow provides an analytical estimate as compared to a numerical estimate, which require use of reservoir simulation software that is expensive and not easily accessible.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for carbon dioxide injection and storage, comprising:
obtaining a set of inputs from a potential site comprising a reservoir;
obtaining a set of operating parameters related to the potential site;
accumulating a volume of data that is processed in a defined time to produce a predictive model that is an analytical model;
determining, with the predictive model, one or more predicted outputs based on the inputs and the set of operating parameters;
validating, based on the one or more predicted outputs and without performing any numerical model simulation, the potential site as suitable for carbon dioxide injection and storage, wherein one of the one or more predicted outputs is a target size of the resulting carbon dioxide plume;
deploying a carbon dioxide injection system at the validated site; and
injecting, using the deployed carbon dioxide injection system, carbon dioxide into the reservoir of the validated site based on the set of operating parameters.

2. The method of claim 1, further comprising:
adjusting with a well controller of the carbon dioxide injection system, the set of operating parameters based on the on the one or more predicted outputs.

3. The method of claim 1,
wherein the predicted outputs are selected from a group comprising plume radius, storage efficiency, formation volume factor, migration velocity, and build-up pressure of carbon dioxide, and
wherein validating the potential site is based at least on the predicted plume radius reaching a target plume radius to satisfy a carbon dioxide storage volume requirement.

4. The method of claim 2, wherein plume radius is determined with an explicit integral solution.

5. The method of claim 2, wherein storage efficiency is determined with carbon dioxide volume injection rate at end of time t and pore volume.

6. The method of claim 2, wherein formation volume factor depends on a ratio of the carbon dioxide volume at reservoir conditions and the carbon dioxide volume at surface conditions.

7. The method of claim 2, wherein migration velocity depends on reservoir inclination, carbon dioxide relative permeability, and density differential between brine and carbon dioxide.

8. The method of claim 2, wherein build-up pressure is determined with an explicit integral solution.

9. The method of claim 1, wherein the set of operating parameters is selected from a group consisting of carbon dioxide injection rate, carbon dioxide injection time, carbon dioxide pressure, and total carbon dioxide injection volume.

10. The method of claim 1, wherein the one or more predicted outputs require one or more intermediate outputs comprising a group consisting of reservoir temperature, reservoir pressure, carbon dioxide viscosity, brine density, brine viscosity, carbon dioxide density, carbon dioxide relative permeability, brine relative permeability, select permeability values, and total carbon dioxide injection volume.

11. A carbon dioxide storage system, comprising:
a potential site comprising a reservoir, wherein a carbon dioxide injection operation of the potential site is defined by a set of operating parameters;
a plurality of wellsite devices disposed at the potential site and gathering a set of inputs;
a carbon dioxide injection system deployed at the potential site in response to a validation;
a computer configured to:
obtain the set of inputs from the potential site,
obtain the set of operating parameters related to the potential site,
accumulate a volume of data that is processed in a defined time to produce a predictive model,
determine, with the predictive model, one or more predicted outputs based on the set of inputs and the set of operating parameters,
generate, based on the one or more predicted outputs and without performing any numerical model simulation, validation that the potential site is suitable for carbon dioxide injection and storage, wherein one of the one or more predicted outputs is a target size of the resulting carbon dioxide plume, and
adjust, automatically, the set of operating parameters based on the predictive model;
a well controller configured to adjust one or more wellsite devices for injecting carbon dioxide into the reservoir based on the adjusted set of operating parameters; and
a source of carbon dioxide.

12. The system of claim 11, wherein the set of inputs comprises of surface temperature, temperature gradient, reservoir depth, pressure gradient, salinity, carbon dioxide residual saturation, brine residual saturation, reservoir thickness, reservoir porosity, carbon dioxide injection rate, carbon dioxide injection time, carbon dioxide pressure, structural dip, permeability, carbon dioxide saturation in plume, rock compressibility, brine compressibility, and specified build-up pressure value.

13. The system of claim 11, wherein the one or more predicted outputs are selected from a group consisting of plume radius, storage efficiency, formation volume factor, migration velocity, and build-up pressure of carbon dioxide.

14. The system of claim 11, wherein plume radius is determined with an explicit analytical solution.

15. The system of claim 11, wherein storage efficiency is determined with carbon dioxide injection rate at end of time t and reservoir porosity.

16. The system of claim 11, wherein formation volume factor depends on a ratio of the carbon dioxide volume at reservoir conditions and the carbon dioxide volume at surface conditions.

17. The system of claim 11, wherein migration velocity depends on reservoir inclination, carbon dioxide relative permeability, and density differential between brine and carbon dioxide.

18. The system of claim 11, wherein build-up pressure is determined with an explicit integral solution.

19. The system of claim 11, wherein the set of operating parameters is selected from a group consisting of carbon dioxide injection rate, carbon dioxide injection time, carbon dioxide pressure, and total carbon dioxide injection volume.

20. The system of claim 11, wherein the one or more predicted outputs require one or more intermediate outputs comprising a group consisting of reservoir temperature, reservoir pressure, carbon dioxide viscosity, brine density, brine viscosity, carbon dioxide density, carbon dioxide relative permeability, brine relative permeability, select permeability values, and total carbon dioxide injection volume.
